(19) United States
(12) Patent Application Publication
(10) Pub. No.: US 2014/0122225 A1
(43) Pub. Date: May 1, 2014

(54) ADVERTISER DRIVEN ENGAGEMENT FOR PRODUCT SEARCHES

(71) Applicant: YAHOO! INC., Sunnyvale, CA (US)

(72) Inventors: Deepak Kumar Vasthimal, Bangalore (IN); Sriram Srinivasan, Bangalore (IN)

(73) Assignee: YAHOO! INC., Sunnyvale, CA (US)

(21) Appl. No.: 13/663,192

(22) Filed: Oct. 29, 2012

(51) Int. Cl. G06Q 30/02

(52) U.S. Cl. 705/14.49

(57) ABSTRACT

An advertiser-driven single page product search and purchase process may be simplified for consumers. When a product search is performed, a single page may be rendered to the consumer that includes the necessary information to enable a consumer to avoid multiple searches and switching frequently between other tabs and pages. The single page may also provide an option to the advertiser to monitor these interactions so that the advertiser may perform an active role in the product search and purchase process.

### BACKGROUND

Online advertising may be an important source of revenue for enterprises engaged in electronic commerce. Processes associated with technologies such as Hypertext Markup Language (“HTML”) and Hypertext Transfer Protocol (“HTTP”) enable a web page to be configured to display advertisements (“ads”). Ads may commonly be found on many web sites. Web site publishers, such as news and sports web sites, may provide space for ads, referred to as ad slots or ad containers. The publishers of these web sites may sell advertising space to advertisers to defray the costs associated with operating the web sites as well as to obtain additional revenue. Electronic commerce (“ecommerce”) sites may include advertisements that are targeted to users based on those products that the user is searching for. The product searches may be conducted in a search engine (e.g. www.yahoo.com) or on a specific ecommerce site.

Searches for products on search engines or ecommerce sites may yield a page of links along with images, price and/or reviews. There may be many additional tasks that are not provided as part of the search result page and are required of the user. For example, selection, feature comparison, price comparison, choosing nearest store, may all be required of the user. Accordingly, these tasks may require more searches and page views resulting in poor engagement for the user.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 is a diagram of an exemplary advertisement generator;

FIG. 3 is a diagram of exemplary elements; and

FIG. 4 illustrates exemplary dynamic elements.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

By way of introduction, an advertiser-driven single page product search and purchase process may be simplified for consumers or end users. When a product search is performed, a single page may be rendered to the user. That page may include the necessary information to prevent a user from performing multiple searches and switching frequently between other tabs and pages. The page may also provide an option to the advertiser to monitor these interactions. For example, the portions of the page the user spends the most time may be monitored in real time. The advertiser may perform an active role in the product search and purchase process through real time monitoring.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

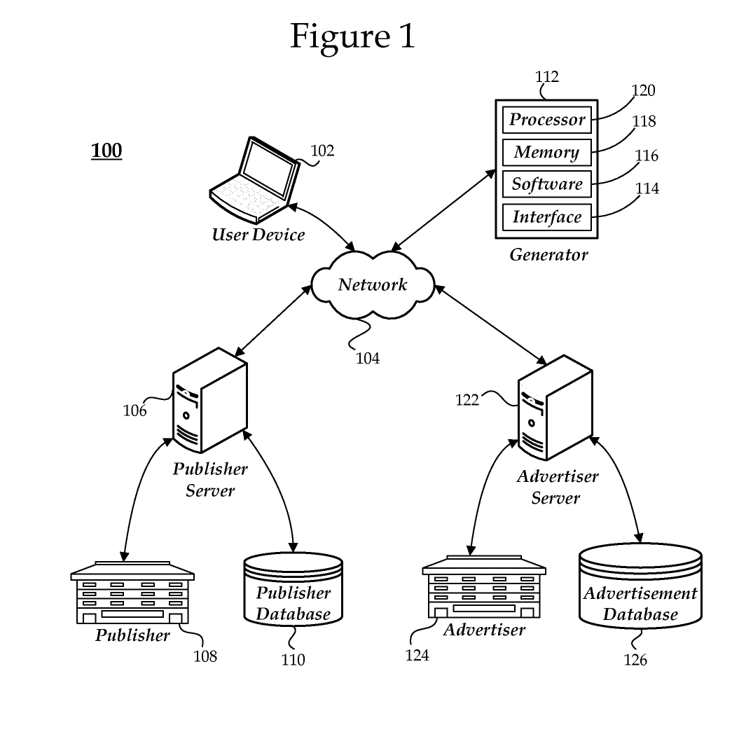

FIG. 1 depicts a block diagram illustrating one embodiment of an exemplary advertising system 100. The advertising system 100 may provide a platform for packaging an advertisement, its visual elements, and logic for rendering the advertisement on different devices. In the advertising system 100, a user device 102 is coupled with a publisher server 106 through a network 104. The publisher server 106 may be operated by and/or coupled with a publisher 108, as well as being coupled with a publisher database 110. An advertiser server 122 coupled with an advertiser 124 may also be coupled with an advertisement database 126. A generator 112 may be coupled with the publisher server 106 and the advertiser server 122. The generator 112 may also be referred to as a monitor because it generates a product page or product search result page, as well as monitoring or tracking interaction with the page for an the advertiser. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided. Accordingly, the generator 112 may be coupled through a network (e.g. the network 104) with the advertiser server 122. In alternative embodiments, the generator 112 may be a part of the advertiser server 122.

The user device 102 may be a computing device which allows a user to connect to a network 104, such as the Internet. The user may also be referred to as a consumer and accesses a product search page or a product page from an ecommerce site. The accessed page may include multiple elements for improving a user experience as well as for providing tracking information for an advertiser to target. The user device 102 may also be referred to as a client device and may include a computing device capable of sending or receiving signals, such as via a wired or a wireless network (e.g. the network 104, which may be the Internet). The user device 102 may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. The user device 102 may vary in terms of capabilities or features, particularly with regard to display size and aspect ratio. The different display sizes and aspect ratios for different user devices may result in an advertisement being rendered differently for those particular user devices. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

The user device 102 may include or may execute a variety of operating systems, including a personal computer operating system, such as a Windows, iOS or Linux, or a mobile operating system, such as iOS, Android, or Windows Mobile, or the like. The user device 102 may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. The user device 102 may also include or execute an application to communicate content, such as, for example, textual content, multimedia content, or the like. The user device 102 may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities. As described below, the user device 102 views a product search page that includes multiple functionality that may be monitored by the advertiser 124.

In one embodiment, the user device 102 is configured to request and receive information from a network (e.g. the network 104, which may be the Internet). The information may include web pages with advertisements. The user device 102 may be configured to access other data/information in addition to web pages over the network 104 using a web browser, such as INTERNET EXPLORER® (sold by Microsoft Corp., Redmond, Wash.) or FIREFOX® (provided by Mozilla). In an alternative embodiment, software programs other than web browsers may also display pages received over the network 104 or from a different source. As described below, product search page may include numerous features and advertisements on a single page that may be monitored in real time.

In one embodiment, the publisher server 106 provides an interface to a network 104 and/or provides its web pages over the network, such as to the user device 102. The publisher server 106 may be a web server that provides the user device 102 with pages (including product search results) that are requested over the network, such as by a user of the user device 102. In particular, the publisher 108 may provide a web page, or a series of web pages that are provided by the publisher server 106 when requested from the user device 102. The publisher server 106 may be operated by a publisher 108 that maintains and oversees the operation of the publisher server 106. The publisher 108 may be any operator of a page displaying advertisements that receives a payment from the advertisers of those advertisements. In one embodiment, page may be an ecommerce page that provides products information and product search functionality.

The publisher database 110 may be coupled with the publisher server 106 and may store the publisher's pages or data that is provided by the publisher server 106. The stored data may include product information as well as data analyzing the products for sale on the page. As described herein, an ecommerce site may sell products, but the “product” for sale (or rent/lease/loan) may also include a service, digital content, or any other non-tangible items. The product search result pages, as well as the product pages may be stored in the publisher database 110. As described with respect to FIG. 3 below, the elements of the product search page may also be stored in the publisher database 110.

The product search page and/or product pages may also display one or more advertisements, such as an advertisement provided by the advertiser server 122. The advertisements may be displayed in web pages (e.g. product search pages), such as the publisher's pages. In one embodiment, the advertiser server 122 is coupled with the publisher server 106 for providing ads with product search results. The advertiser 124 may be any operator of the advertiser server 122 for providing advertisements and for monitoring user interaction with the page and product search results.

The publisher server 106 and/or the advertiser server 122 may be one or more computing devices which may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In addition, the publisher server 106 and/or the advertiser server 122 may be or may be part of a content server. A content server may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc. A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

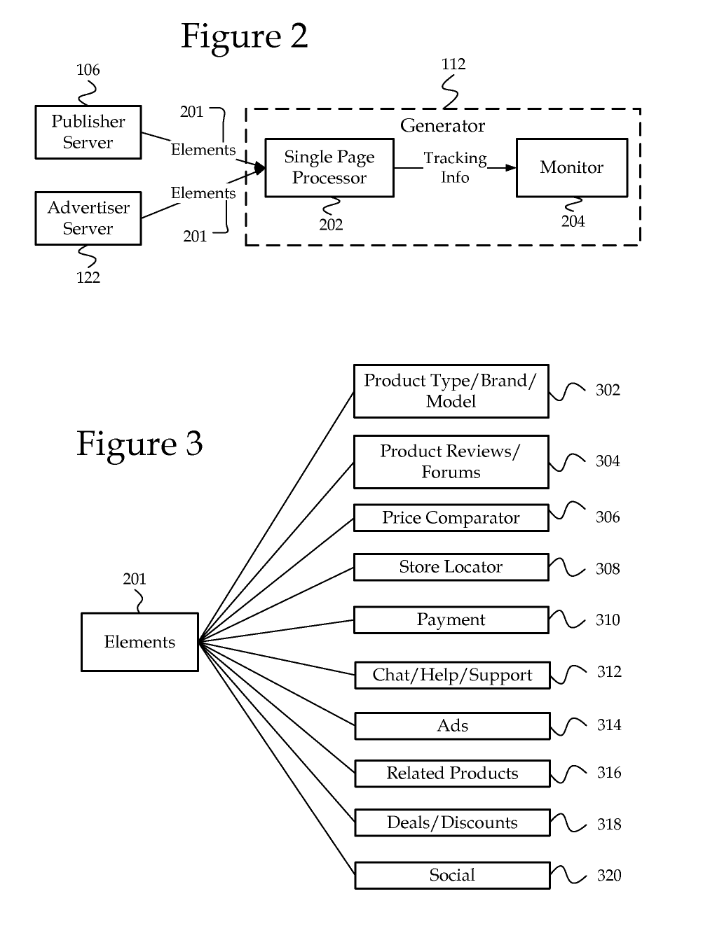

The generator 112 may perform two functions. First, the generator 112 may generate a single product page with a number of elements that allows users to have additional information about a product without clicking back and forth between multiple pages and multiple tabs. Second, the generator 112 may include a monitor or tracker that allows an advertiser (e.g. the advertiser 124) to monitor or track a user's interactions with the page and its elements. In one embodiment, the generator 112 may be controlled by the advertiser 124 and may be a part of the advertiser server 122. In another embodiment, the generator 112 may be controlled by the publisher 108 and may be a part of the publisher server 106. Alternatively, the generator 112 may be part of a separate entity. The generator 112 may receive elements from the advertiser server 122 and/or the publisher server 106 that are used as part of a product page or a product search result page. The generator 112 is further described with respect to FIG. 2.

The generator 112 may be a computing device for generating a product or product search result page with a plurality of elements and for monitoring user interaction with those elements and the page. The generator 112 may include a processor 120, memory 118, software 116 and an interface 114. The generator 112 may be a separate component from the publisher server 106 and/or the advertiser server 122, or may be combined as a single component or device.

The interface 114 may communicate with any of the user device 102, the publisher server 106, and/or the advertiser server 122. The interface 114 may include a user interface configured to allow a user and/or administrator to interact with any of the components of the generator 112. For example, the administrator and/or user may be able to generate a single product page and monitor user interaction with that page.

The processor 120 in the generator 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with a memory 118, or the memory 118 may be a separate component. The interface 114 and/or the software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116. The software 116 may include instructions for generating a product page with a plurality of elements and for monitoring user interaction with that page and the elements.

The interface 114 may be a user input device or a display. The interface 114 may include a keyboard, keypad or a cursor control device, such as a mouse, or a joystick, touch screen display, remote control or any other device operative to interact with the generator 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly. Any of the components in the advertising system 100 may be coupled with one another through a network, including but not limited to the network 104. For example, the generator 112 may be coupled with the publisher server 106 and/or the advertiser server 122 through a network. As another example, the advertiser database 126 may be coupled with the publisher server 106 and/or the generator 112 through a network. Accordingly, any of the components in the advertising system 100 may include communication ports configured to connect with a network, such as the network 104.

The network (e.g. the network 104) may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

The network connecting the devices described above (e.g. the network 104) may be a “content delivery network” or a “content distribution network” (CDN). For example, the publisher server 106 and/or the advertiser server 122 may be part of a CDN. A CDN generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Likewise, the network connecting the devices described above (e.g. the network 104) may be a peer-to-peer (or P2P) network that may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.” For example, the ad server 122 or the publisher server 106 may provide advertisements and/or content to the user device 102 over a P2P network, such as the network 104.

The publisher server 106, the publisher database 110, the generator 112, the advertiser server 122, the advertiser database 126, and/or the user device 102 may represent computing devices of various kinds. Such computing devices may generally include any device that is configured to perform computation and that is capable of sending and receiving data communications by way of one or more wired and/or wireless communication interfaces, such as interface 114. For example, the user device 102 may be configured to execute a browser application that employs HTTP to request information, such as a web page, from the publisher server 106. The present disclosure contemplates the use of a computer-readable medium that includes instructions or receives and executes instructions responsive to a propagated signal, so that any device connected to a network can communicate voice, video, audio, images or any other data over a network.

FIG. 2 is a diagram of an exemplary generator 112. The generator 112 may include a single page processor 202, which may include or be the same as the processor 120 discussed above. The generator 112 may further include an ad monitor 204. The advertiser server 122 and/or the publisher server 106 may provide elements 201 for generating a single page for a product or product search results. Exemplary elements 201 are further described below with respect to FIG. 3. The single page processor 202 receives the elements 201 for generating a single page. The single page may be part of an ecommerce site that minimizes user clicks during a shopping experience. By including the elements 201 on a single page, the shopping experience for the user may be simplified and shortened.

The generator 112 may also include a monitor 204 that tracks or monitors a user's interaction with the single page and the elements on that single page. The monitoring may be in real time and the tracking information regarding a user's interaction with the single page and its elements are directly available to the advertiser 124 and/or the publisher 108. In particular, the user interactions with the elements of the single page are tracked in real-time for the advertiser to make real time decisions on targeted advertisements on the page, as well as changes/updates to the elements displayed by the publisher 108.

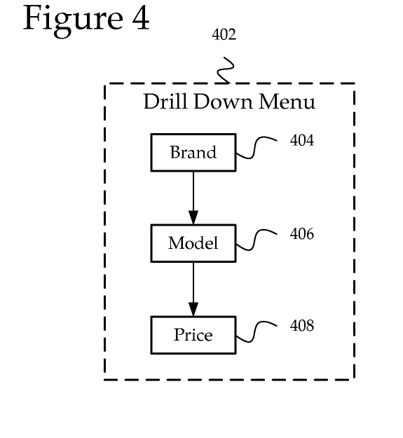

FIG. 3 is a diagram of exemplary elements 201 for a product or product search results page. The elements 201 may include features or components that are part of a complete shopping experience for a user. The elements 201 may be selected and displayed to minimize movement of the user from the single page displaying those elements 201. In alternative embodiments, there may be additional or fewer elements 201 displayed as part of the single page and the elements 201 shown in FIG. 3 are merely exemplary. As described the single page may be related to ecommerce. Accordingly, it may be referred to as a product page or a product search results page. The product page may include functionality for viewing a particular product and/or searching for additional products as part of a shopping/ecommerce experience. As described with respect to FIG. 4, the elements 201 may not all be displayed together and may be displayed as a user drills down and narrows products by selecting others of the elements 201. Accordingly, the single page may display a subset of the elements 201, but as the user interacts with those displayed elements, additional elements are revealed/displayed.

Although not illustrated in FIG. 3, the page may include a product search feature or menu/directories/links for browsing additional products. For a particular product, a product type, product brand, and model number 302 may be displayed. As discussed with respect to FIG. 4, the type, brand, model, and price may be elements that are displayed as the user “drills-down” in the in menu options. Product reviews and/or forums 304 may also be displayed for providing additional product information. By displaying the elements 201 on a single page, the user does not need to click back-and-forth between a product page and reviews/forums to read about the product and see other user reviews. A price comparator 306 may provide the product's price, along with prices for additional or related products. A store locator 308 provides a physical store location that sells the product along with available inventory and directions to the store. Payment 310 includes price, shipping, and method of payment information. In one embodiment, the payment details may only be displayed after the user indicates a desire to purchase the product.

Additional elements 201 include a chat/help/support 312 element may include real-time chat with customer service, help files, and/or technical support options for information about the product. The page may include ads 314 that may be targeted to a user and/or targeted based on the product or the elements that the user interacts with. The ads 314 may be selected or modified based on the tracking info provided for the monitor 204 and may include sponsored listings or partner results as part of the results for a product search. The tracking info may include any information that enables a better understanding of the user. For example, the tracking info may include geo-location (e.g. through IP tracking or GPS through a mobile device), social information extracted from a social graph that the user is part of, search history etc. Related products 316 may be similar products and may be displayed as part of the price comparator 306 element. In addition to related products, accessories for the product may also be displayed. Deals, discounts, and coupons 318 may be displayed as another option. Finally, there may be a social element 320 that includes the ability to see what others in your social network (e.g. friends, family) have purchased and also display to others the products that you would like to purchase or have purchased.

The elements 201 that are shown as part of the single page are dynamic. The elements 201 that are displayed may change depending on the product and the user. For example, when a user interacts with a particular element that may result in other elements being displayed. FIG. 4 illustrates exemplary dynamic elements. The elements that are displayed along with the user interaction of those elements may determine which elements are displayed. The page may include a drill down menu 402 that includes dynamic elements that are displayed based on interaction. In the FIG. 4 example, the user may select a brand 404, which then triggers a model element to be displayed. When the user selects the model 406, then a price 408 element may be displayed for that particular model. The price may not be displayed until the brand and model are first selected in this example. In other examples, additional elements may be displayed based upon user interaction. For example, the price comparator element may be displayed after the price 408 is displayed.

The elements 201 that are displayed may be based on a ranking. The ranking may include a monetization analysis based on ad revenue for the page depending on the elements displayed as well as the number of times the product is purchased. The ad revenue may be based on content based ads and/or sponsored listings as part of product search results. The ranking of the elements may be based on relevance/monetization capability. A score may be computed based on a likelihood of the user purchasing a product. For example, since chat support requires a human resource and is expensive, this element may be displayed on the page if the user is likely to purchase the product. This allows businesses to differentiate between users who are window-shopping against those who are genuinely interested in buying. The likelihood of the user purchasing the product may be computed by computing a score using various features. Exemplary features include time spent on the page and/or granularity of the user's activity. For example, granularity may be when the user has narrowed down his/her interest to a particular model/brand after clicking on the drill down menu, or when the user is looking for a store nearby. A social element may be displayed if the user has purchased items based on his friend's recommendations (e.g. if he clicked on a social ad while he was logged into a social networking site, etc).

The elements 201 may also be referred to as data sources or tasks and generally relate to information that is displayed to a user about a product or product search. The elements that are displayed and the user interaction with those elements may be monitored by the monitor 204. The monitoring may be used by the publisher for dynamically modifying which elements are displayed and dynamically updating content of those elements. The monitoring may further be used by the advertiser for targeting advertisements.

A product search may trigger a request from an advertiser site. There may be an algorithm to determine out which advertisers and advertisements should be shown. The advertiser data for the product may be included in the single page and put into different elements and/or different ads. The advertiser may monitor the actions of the user on the page, including which brand/version is of interest among the various products offered. For example, a particular user may prefer a particular brand because of price concerns. This information may be provided to the advertiser in real time so the advertiser can advertise a budget product rather than a higher-end product. Likewise, if the advertiser observes an interesting interaction (e.g. genuine interest in purchase/inventory browsing), the advertiser can assign a live chat support for those users. In other words, the real-time monitoring may be used to identify the more serious shoppers from those users who are browsing but probably not interested in making a purchase. While the user is engaging in browsing product offerings, meta-info such as price comparison, store locators, and deals may be provided to the user. This may enable the user to make informed choices. Incentives such as discounts/coupons can be given for those users who refer their friends/contacts to buy from the vendor. These actions may be embedded in the same page.

When a user interacts with a page and/or individual elements of that page, the interactions may be monitored. The interactions may be referred to as tracking information that can be provided to an advertiser in real-time. The advertiser can use the real-time tracking information to specifically target one or more advertisements to the user based on that user's interactions. Because the monitoring and reporting of the tracking data is in real-time, the advertisement can be changed or updated in real-time as the user is still on the site. In another embodiment, the tracking information may be used for updating which elements are displayed and for updating the content of those elements. The element updating may be from the publisher or the advertiser. The updating of the elements is dynamic because an interaction with one element may result in a different element being displayed or hidden. Likewise, the display of an advertisement is dynamic because the real-time tracking information may be used to update the displayed advertisement nearly instantaneously. The real-time tracking may help business make informed decisions immediately. For example, the business owner can see that a user is genuinely interested in buying a product, so the owner can arrange for a human chat support, or generate a coupon/discount just for this user at that time. This may induce the user to make the purchase right away. Real-time tracking provides information for businesses to get a feel of what aspect of their offerings users are interested in, and using this information, they could alter their offerings to better suit the users as well as their interests (revenue, engagement, etc).

As described above, the real-time tracking is real-time info of what a user wants. This information, when extracted from multiple users across multiple locations, gives a business an idea of what the market wants. This information may be valuable and since it is real-time, businesses can tweak their offerings to serve the users better, as well as increase the likelihood of purchase. In addition, the businesses can receive insights on how their competitors are performing, which aspects of their competitors are better than their own, and/or how users react to each of the offerings, etc. Such information is valuable and may be otherwise difficult to access/generate. The real-time information may also be collected for offline processing and help the business understand the consumer's behavior as well as their competitor's offerings. This real-time monitoring feature may be capable of triggering a real-time price war between businesses as well as providing real-time analytics for businesses to target their offerings in an optimal manner.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A method for targeting an advertisement on a single page comprising dynamic elements for display, the method comprising:
providing the single page comprising the dynamic elements for display, wherein the dynamic elements that are displayed on the page varies;
monitoring, in real-time with at least one processor, interactions with the single page and with the dynamic elements;
providing, in real-time, tracking data that includes the monitored interactions to one or more advertisers that provide one or more advertisements to be displayed on the single page; and
updating, in real-time, the dynamic elements on display based on the tracking data.

2. The method of claim 1 wherein the one or more advertisers comprises a first advertiser and a second advertiser, wherein the one or more advertisements comprises a first advertisement and a second advertisement, further wherein the single page displays the first advertisement from the first advertiser and displays the second advertisement from the second advertiser.

3. The method of claim 2 wherein the tracking data is provided to both the first advertiser and the second advertiser.

4. The method of claim 3 wherein the first advertisement is updated by the first advertiser in real time based on the tracking data.

5. The method of claim 3 wherein the second advertisement is updated by the second advertiser in real time based on the tracking data.

6. The method of claim 1 wherein the tracking data comprises user interaction with the single page, user interaction with the dynamic elements, user interaction with the one or more advertisements, and/or profile information about the user.

7. The method of claim 1 wherein the single page comprises a product page from an ecommerce site.

8. The method of claim 7 wherein the dynamic elements comprise at least one of a product type, product brand, product model, pricing information, price comparison, store locator, product search functionality, support information, reviews, or related products.

9. The method of claim 1 wherein the updating of the dynamic elements comprises identifying which of the dynamic elements to display based on the user interaction.

10. The method of claim 9 wherein the interaction of one of the dynamic elements results in a display of another one of the dynamic elements.

11. A non-transitory computer readable medium having stored therein data representing instructions executable by a programmed processor for targeted advertisements in a page, the storage medium comprising instructions operative for:
providing the page with a plurality of elements and at least one advertisement;
monitoring interaction with the elements and the at least one advertisement in the page;
providing real-time tracking information to an advertiser based on the monitoring;
receiving requests to modify the advertisements in a page based on the real-time tracking information; and
updating the elements displayed in the page based on the real-time tracking information.

12. The computer readable medium of claim 11 wherein the requests to modify the advertisements are from the advertiser.

13. The computer readable medium of claim 11 wherein the advertiser provides requests to update the elements displayed in the page based on the real-time tracking information.

14. The computer readable medium of claim 11 wherein the elements displayed on the page varies and the updating changes which elements are displayed.

15. The computer readable medium of claim 14 wherein the updating of the elements comprises identifying which of the elements to display based on the interaction.

16. The computer readable medium of claim 14 wherein the interaction of one of the elements results in a display of another one of the elements

17. The computer readable medium of claim 11 wherein the tracking data comprises user interaction with the single page, user interaction with the dynamic elements, user interaction with the one or more advertisements, and/or profile information about the user.

18. The computer readable medium of claim 11 wherein the page comprises a web page for a product.

19. The computer readable medium of claim 11 wherein the elements comprise at least one of a product type, product brand, product model, pricing information, price comparison, store locator, product search functionality, support information, reviews, or related products.

20. A system for targeting by an advertiser over a network, the system comprising:
a publisher server for providing a page that is comprised of at least one of a plurality of elements;
an advertiser server for providing, from an advertiser, an advertisement for the page;
a generator for identifying which of the elements to include as part of the page and for including the advertisement on the page; and
a monitor for tracking user interaction with the elements, wherein the tracking is provided in real-time to the advertiser and the advertisement that is provided is updated based on the tracking, further wherein the elements that are included as part of the page are modified in real-time based on the tracking.
